(19) United States
(12) Patent Application Publication
(10) Pub. No.: US 2009/0261305 A1
(43) Pub. Date: Oct. 22, 2009

(54) COMPOSITION OF AND METHOD OF USING NANOSCALE MATERIALS IN HYDROGEN STORAGE APPLICATIONS

(75) Inventors: Daniel F. CARROLL, Westlake, OH (US); Kimberly McGRATH, Newport Beach, CA (US); Keith KEPLER, Belmont, CA (US)

Correspondence Address: KNOBBE MARTENS OLSON & BEAR LLP, 2040 MAIN STREET, FOURTEENTH FLOOR, IRVINE, CA, 92614, US

(73) Assignee: QUANTUMSPHERE, INC., Santa Ana, CA (US)

(21) Appl. No.: 12/427,221

(22) Filed: Apr. 21, 2009

Related U.S. Application Data
(60) Provisional application No. 61/046,790, filed on Apr. 21, 2008.

(51) Int. Cl. H01B 1/22

(52) U.S. Cl. 252/513; 252/512; 252/514; 977/810

(57) ABSTRACT

A composition for use, for example, in an electrode in a Nickel-Metal-Hydride battery is provided that consists of metal hydrides together with a certain percentage of nano-sized reactive metal particles, preferably either nickel, manganese, aluminum, cobalt, copper, tin, palladium, silver, gold, lanthanum, and/or alloys thereof. The addition of nano-metals enhances the hydrogen charging characteristics of the battery.

### CROSS-REFERENCE TO RELATED APPLICATIONS

This application is based on and claims priority to U.S. Provisional Patent Application No. 61/046,790, filed on Apr. 21, 2008, and entitled “COMPOSITION OF AND METHOD OF USING NANOSCALE MATERIALS IN HYDROGEN STORAGE APPLICATIONS,” the entire contents of which is hereby expressly incorporated by reference.

### BACKGROUND

1. Field

The disclosure generally relates to electrodes and applications utilizing electrodes, such as batteries and fuel storage devices.

2. Description of the Related Art

Solid state storage of hydrogen via absorption into a chemical or metal hydride matrix is widely viewed as a promising alternative to storage of hydrogen as a liquid or under high compression as a gas. The principle is presently used in rechargeable batteries such as nickel-metal hydride (NiMH) batteries, in which hydrogen is reversibly absorbed into the anode electrode during battery cycling. By increasing the rate of the hydrogen absorption-desorption reaction, the rate capability of the battery can be improved. Over the last 30 years, considerable effort by researchers around the world has been directed towards improvement of NiMH electrodes and batteries to extend their commercial applications, as these batteries present a number of positive characteristics, such as previous market-proven durability, relatively low cost, no toxic materials (such as cadmium), safety, and good specific energy (˜280 Wh/l) and energy density (˜80 Wh/kg).

In a NiMH battery anode, the active materials are typically AB₅ rare-earth alloys containing predommantly La, Ce, Pr, and Nd (mischmetal), Al or Ni. Considerable efforts have been focused on the development of an improved composition by the incorporation of other elements into the alloy. In an effort to increase capacity and service life, Matsumara et al. have added group VIIB, group VIII, and group IB elements into the alloy through the use of acidic treatments. Additionally, Fetcenko et al. have focused on hydrogen storage alloys containing V, Ti, Zr, Ni, Zr, Co, Mn, Fe, and Sn to improve energy density, cycle life, and low temperature performance. Ovshinsky and Young added palladium into the alloy for improved rate capability, and Jacobus et al. added Ni, Pd, Pt, Ir or Rh via electroless plating upon the surface of the base alloy to improve low temperature operational performance. More recently, Yuko et al. focused on the addition of a layer of fine Ni particles on one face of a hydrogen absorbing alloy to improve current collection and rate capability. The layer was formed by blade casting a paste of Ni particles in a copolymer to an iron sheath which is in contact with the outer anode can of the battery. Likewise, Nakayama et al. provided a layer of fine Ni atop a carbon layer in proximity to the current collector face.

While the prior art hydrogen storage alloys and negative electrode modified compositions improve at least one battery performance characteristic, most were focused on the complex integration of new metals alloyed into the base matrix and therefore additional chemical preparations steps were necessary to form new base alloys. This can provide significant cost increases that inhibit commercialization, especially if the integration requires more processing steps or if the material to be integrated is a precious metal. Furthermore, by coating only the surface of the anode electrode with fine particles, many of the potential benefits are lost as Ni, in and of itself, is an active material in the kinetics of hydrogen absorption and de-sorption. Additionally, the prior art does not describe the role of metal oxide additives in the improvement of NiMH anode electrode kinetics. For example, Yusa discloses that the method of preparation requires steps to prevent the formation of any oxide on nanoparticles.

### SUMMARY

Described herein are compositions and uses of nanoscale additives in electrode and/or hydrogen storage applications. Compositions are provided that comprise or that consist of metal hydrides together with a certain percentage of nano-sized reactive metal particles, preferably nickel, manganese, aluminum, cobalt, copper, tin, palladium, silver, gold, lanthanum, and/or combinations or alloys thereof. The addition of nano-metals enhances the hydrogen charging characteristics of the battery. These compositions have use, for example, in an electrode in a Nickel-Metal-Hydride battery as well as a hydrogen storage material in a fuel cell or hydrogen combustion engine.

In at least one embodiment, a composition is provided comprising a metal hydride and a plurality of nano-sized particles of reactive metal particles. The composition can be suitable for application as an electrode in a nickel-metal hydride battery or hydrogen storage material in a fuel storage system.

In various embodiments, the nano-sized metal particles can comprise between 0.1 wt % and 30 wt % of the overall composition, such as between 1 wt % and 5 wt % or between 5 wt % and 10 wt % of the overall composition. The nano-sized metal particles can be selected from groups IIA, IB, and IIIB-VIIIB of the periodic table. For instance, the nano-sized metal particles can comprise one or more of nickel, manganese, aluminum, cobalt, copper, tin, palladium, silver, gold, lanthanum, and/or alloys thereof. The metal hydride can comprise a multi-component alloy with a nickel and/or nickel alloy enriched surface coating.

In at least one embodiment, an electrode is provided comprising any of the compositions described above. In at least one embodiment, a hydrogen storage device is provided comprising any of the compositions described above.

### BRIEF DESCRIPTION OF THE DRAWINGS

FIG. 1 is a TEM microscope image of a metal particle with an oxide shell.

FIG. 2 illustrates discharge curves at C-Rate for NiMH coin cells using various anode nanoparticle additives.

FIG. 3 illustrates percentage of capacity as a function of hours charged after formation.

FIG. 4 illustrates the percentage of capacity as a function of percent overcharge.

### DETAILED DESCRIPTION

As used herein, the term “nanoparticle” refers to a particle with a maximum dimension of from about 1 to about 999 nanometers (10⁻⁹ meters). Because the particles are generally spherical in some embodiments, this dimension is also referred to herein as the “effective diameter” of a particle, although other shapes are also observed. The number of atoms comprising a nanoparticle rapidly increases as nanoparticle size increases from ones to hundreds of nanometers. Roughly, the number of atoms increases as a function of the cube of the particle's effective diameter. Nickel nanoparticles, for example, have about 34 atoms in a 1 nm particle, about 34 million atoms in a 100 nm particle, and about 34 billion in a 1 micron particle.

By virtue of their high surface area to volume ratio, nanoparticles exhibit improved catalytic activity relative to larger particles with comparable material compositions. Consequently, when a metal, metal alloy, and/or oxide particle diameter is on the nano-scale, associated catalytic properties are dramatically enhanced in some embodiments. The preparation of such nanoparticle catalysts has been described, for example, in U.S. Pat. No. 7,282,167 to Carpenter (filed on May 6, 2004) (issued Oct. 16, 2007), which is hereby incorporated by this express reference.

In certain embodiments, a composition is provided comprising metal nanoparticles and a hydrogen absorbing alloy. The composition preferably has an increased rate of absorption-desorption kinetics in hydrogen storage and electrochemical applications, for example a nickel-metal hydride battery anode electrode. In certain embodiments, the metal nanoparticles have a metal core and an oxide shell. In certain embodiments, the metal nanoparticles are coated on the hydrogen absorbing alloy. In certain embodiments, the metal nanoparticles are mixed directly within and proximal to the hydrogen storage alloy for improved rate capability of the NiMH battery anode, as well as improved low temperature kinetics. This composition is advantageously accomplished without the need for additional electrode manufacturing steps, which can contribute to increased battery cost.

In certain embodiments, a composition is provided that comprises a plurality of metal particles, and a metal or chemical hydride hydrogen storage material. Preferably, the hydrogen storage material is a metal hydride containing mischmetal, and most preferably a multi-component alloy with a Ni or Ni alloy/oxide enriched surface coating. The inventors recognize that the addition of metal particles to the hydrogen absorbing materials provides performance enhancement irrespective of the specific composition of the metal hydride alloy.

In order to improve the rate of the hydrogen absorption-desorption reaction within an anode electrode of a NiMH battery without significantly diminishing capacity, it is preferable the metal particles be less than 30 wt % of the overall composition. Most preferably, they are less than 10 wt % of the composition. At a 5 wt % metal particle loading, a decrease in capacity is not observed relative to a similar electrode not containing metal particles.

In certain embodiments, the composition of the metal particles can be a pure metal or an alloy of two or more metals. For example, the metal composition can be selected from groups IIA, IB, and IIIB-VIIIB of the periodic table, most preferably nickel, manganese, aluminum, cobalt, copper, tin, palladium, silver, gold, lanthanum, and alloys thereof.

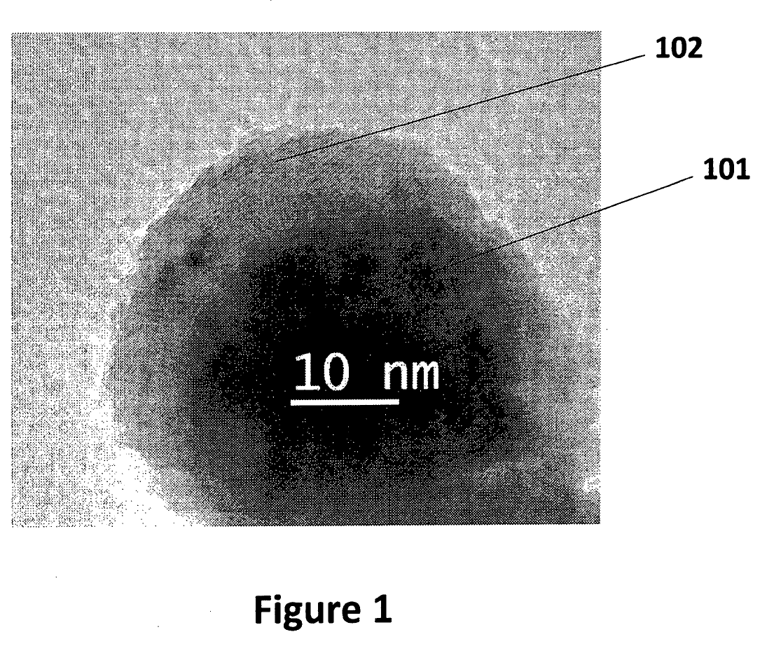

In certain embodiments, the metal particles can be a metal oxide. Referring to FIG. 1, the particles can comprise a core/shell structure as shown on the manganese nanoparticle, in which there is a metal core 101 covered by an oxide shell 102. Preferably, the ratio of oxide shell thickness to particle diameter is greater than 1%, and most preferably at least 5%. The shell oxide is synthetic in the sense that it is not naturally formed by passive oxidation. The thickness is substantially thicker than the native oxide layer that often exists on metal powder particles, which is typically between around 0.03 to 0.1% of the total particle weight. Although it goes against standard convention that catalysis typically occurs better at bare metal surfaces, metal nanoparticles with a metal core/oxide shell structure can potentially facilitate the hydrogen absorption-desorption reaction differently than metal particles (or metal particles with a native oxide). During the charging process, small amounts of oxygen are produced, which can deactivate the metal hydride storage component and lead to performance loss. In the presence of metal nanoparticles with an oxide shell, the oxygen can be adsorbed onto the oxide shell surface instead of the metal hydride, thereby preventing performance deterioration.

In certain embodiments, an anode comprising a plurality of metal particles and a metal or chemical hydride hydrogen storage material is provided. In certain embodiments, the anode comprises a current collector face. In certain embodiments, the metal particles can be proximal to the surface of hydrogen storage material and/or current collector face. For example, the metal particles can be applied as a layer. In certain embodiments, the metal particles can be dispersed within the hydrogen storage material. In certain embodiments, dispersing the metal nanoparticles throughout the anode comprises substituting a certain portion of the metal hydride and replacing it with metal nanoparticles. In certain embodiments, around 5% of metal hydride is substituted for nanoparticles. When the nanoparticles are dispersed within the hydrogen storage alloy, the kinetics of hydrogen desorption reaction increase, giving improved discharge rate capability. Metal nanoparticles can improve conductivity throughout the active layer in the electrode and facilitate the kinetics of hydrogen absorption-desorption. In dispersing the metal nanoparticles throughout the metal hydride, a negligible loss in capacity (at a nanometal loading of 5%), and a significant improvement in discharge kinetics are observed.

In certain embodiments, the metal particles are less than 100 nanometers in size, and more preferably less than 50 nanometers in size. Most preferably, the metal particles are less than 30 nanometers in size, such that the surface area to volume ratio of the particle is large and provides maximum contact with the surfaces of the metal hydride hydrogen storage material.

In an example embodiment, a nickel metal hydride electrode comprises a metal hydride, metal nanoparticles, carbon black, graphite, and a binder applied to a metal matrix as a slurry. Metal nanoparticles are blended with metal hydride, and comprise the bulk of the active material in metal matrix support, typically a reticulate or foam nickel. Additives such as graphite and carbon are added to improve conductivity, and binder is added to substantially adhere the solid materials together and aid in forming the electrode. The metal nanoparticles are dispersed uniformly throughout the metal hydride material. Particle size of the metal hydride is in the range of 20-100 microns, and the average particle size of the metal nanoparticles is less than 30 nm.

In certain embodiments, a battery comprising a plurality of metal nanoparticles dispersed in a metal or chemical hydride hydrogen storage material is provided. In certain embodiments, a battery comprising a plurality of metal nanoparticles having an oxide shell as described herein and a metal or chemical hydride hydrogen storage material is provided. In an example embodiment, a coin cell battery is provided. In the example embodiment, a separator membrane is applied to the anode electrode, followed by application of a cathode electrode comprised of nickel hydroxide (NiOH). Two stainless steel spacers were applied to either side of the electrode, and a few drops of electrolyte were added before the outer battery can was sealed.

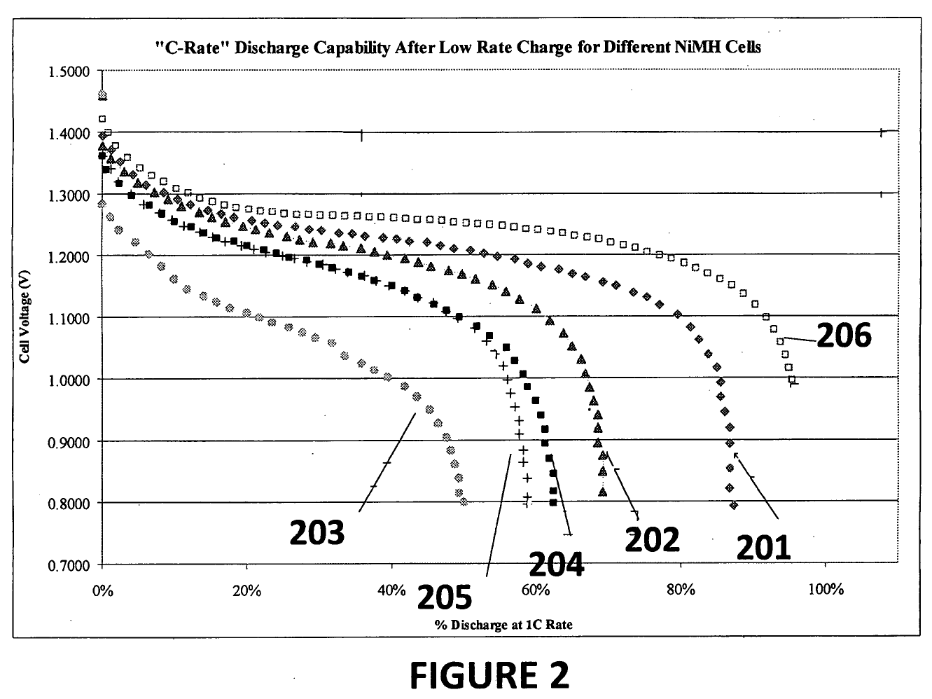

Referring to FIG. 2, the discharge curves of NiMH coin cell batteries with metal nanoparticle-integrated anodes, 201-203, relative to standard coin cells without nanoparticles, 204-205, are described. All cells had similar cathode compositions that were fixed across the entire data set. The cells were discharged a constant rate of 1 C. A commercial battery discharge curve 206 is also illustrated for reference. It is expected that if the preferred anode composition were used in a commercial cell, it would exceed the performance of the standard commercial cell, because the increased impedance of the coin cell gives lower relative performance. In certain embodiments, the metal nanoparticles integrated into the anodes 201-203 comprise a metal core and an oxide shell. In certain embodiments, the average particle diameter can be less than 30 nm, with an oxide shell thickness in the range of 0.5-10 nm. A considerable rate enhancement is observed in an anode electrode with addition of nickel nanoparticles (QuantumSphere, Inc.) 201, versus baseline 204, with over a 25% increase in discharge at 1 V. An anode electrode with addition of manganese nanoparticles 202 also performs better than standard electrode 204. The performance of cobalt nanoparticles was lower than that of the standard and the reasons for this relates to the formation cycle that will be discussed below.

To illustrate the effect of nanoparticle size on performance, a commercially available nickel powder (Alfa Aesar, 80-150 nm) also added at 5 wt % was also tested, and is shown in discharge curve 205. Unexpectedly, performance of this battery fell slightly below baseline 204 and far below the coin cell containing the <30 nm in diameter nickel nanoparticles. This reflects the advantage of using smaller metal particles, in that they can be more thoroughly dispersed within the metal hydride. In addition, we conceive that the metal core/oxide shell structure of the smaller particles also plays a role in the mechanism of function, in that the smaller particles are more reactive and capable of adsorbing additional oxide throughout charge-discharge cycles of battery life.

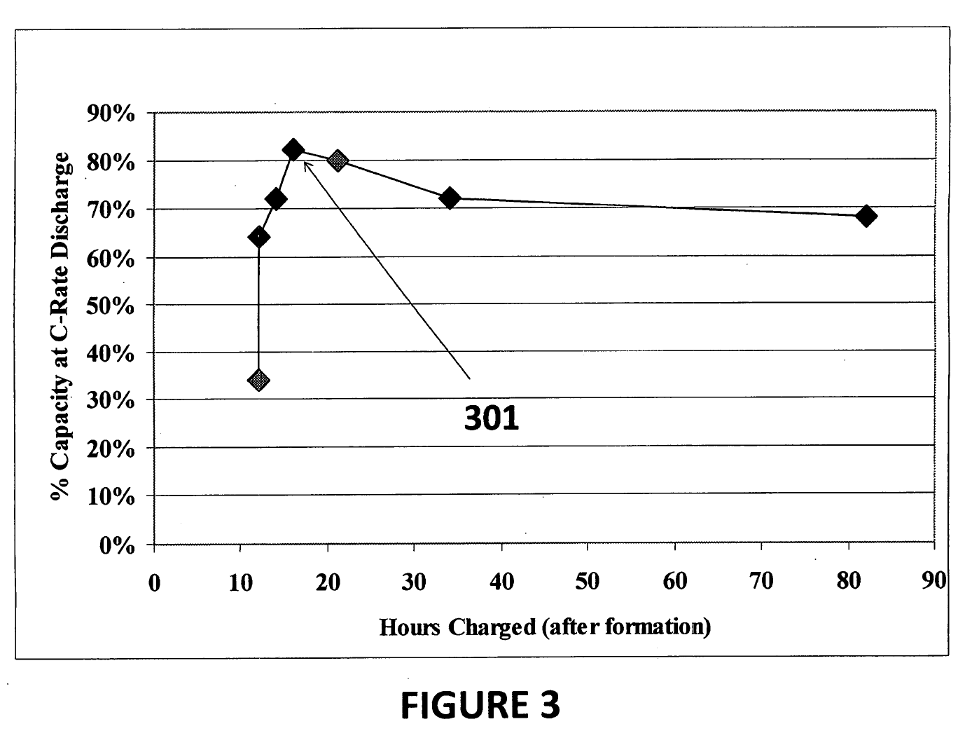

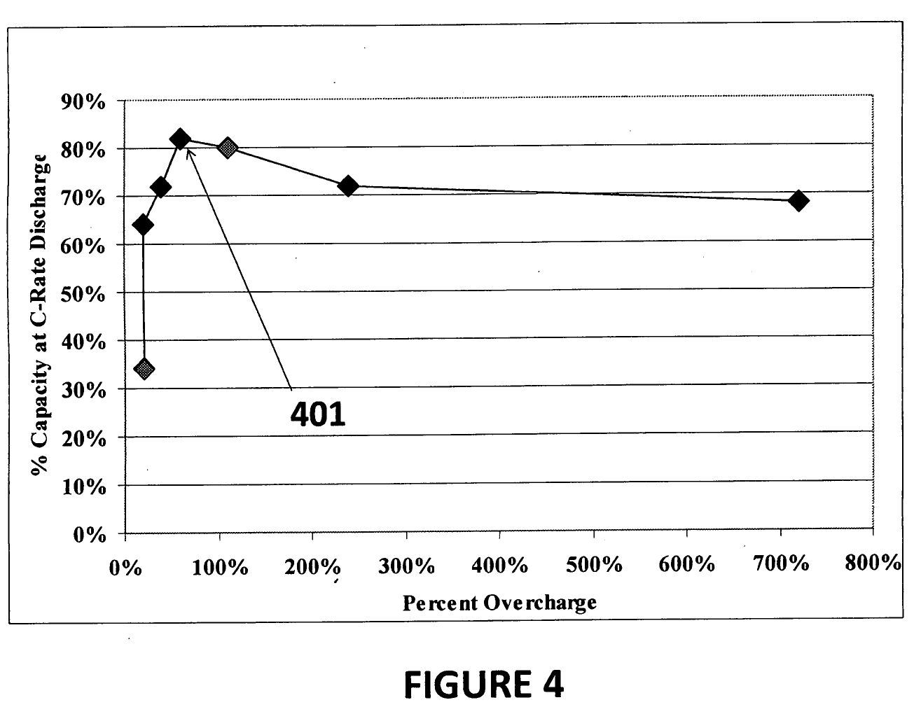

A formation cycle followed by an overcharge cycle was developed to maximize battery performance. The formation cycle consists of 5 cycles at a C/10 rate with a 12 hour charge, 20% overcharge/cycle. The formation cycle was followed by a single 16 hour, 60% overcharge cycle to produce the lowest impedance cells. All cells tested as shown in FIG. 2 were subjected to these steps. Referring to FIG. 3, the 16 hour treatment was selected by studying the % capacity as a function of overcharge time in a coin cell with an anode containing 5 wt % Ni metal nanoparticle additive. Charge time 301 at 16 hours yielded the highest percentage capacity, at time beyond 301, capacity. Referring to FIG. 4, the selection of 60% overcharge was selected by comparing % of overcharge versus capacity. The condition of 60% overcharge 401 yielded the maximum capacity.

It is conceived that the overcharge conditioning step conditions that yield the highest capacity will be dependent on the state of the metal nanoparticle additive, that is, the oxide content of the particle will reach an optimal equilibrium state in a certain amount of time at a certain overcharge percentage. For example, it is possible that the cobalt nanometal additive was not properly overcharged within the anode before discharge testing. If the initial oxide fraction of the particle was initially too large, the 16 hour period may have been too short to reach ideal capacity. Likewise, if the oxide fraction was initially too small, prolonged overcharging may have pulverized or degraded the metal particles as well as the metal hydride.

In certain embodiments, during the formation and conditioning process, the oxide shell fraction of the particle is brought to an equilibrium state, to facilitate uptake of side-reaction oxygen. In certain embodiments, a method for storing hydrogen within a solid matrix is provided. In certain embodiments, the method comprises providing a metal hydride and depositing metal nanoparticles on a face of the metal hydride. In certain embodiments, the method comprises providing a metal hydride and dispersing metal nanoparticles in the metal hydride. The method advantageously allows for more facile transportation of hydrogen, as it will not need to be stored under high pressure conditions or compressed into a liquid. Most preferably, hydrogen uptake from the composition of metal nanoparticles and metal hydride is greater than 3 wt % of the total weight of metal particles and metal hydride, and the temperature of desorption is less than 300° C. Hydrogen, when released from the composition, can be used to directly provide fuel to a hydrogen fuel cell or other thermochemical process.

### EXAMPLE 1

### Preparation of a Negative Electrode

The metal hydride alloy (Chuo Denki Kogyo Co, LTD, Grade 11S), metal nanoparticles (QuantumSphere Incorporated, <30 nm, oxide shell thickness 0.5-10 nm), acetylene black (Chevron), graphite (Timcal) were weighed out and mixed. This solid mixture was then added to a solution of carboxymethylcellulose and styrene butadiene rubber binder and mixed using high-shear blending to form a slurry. The ratio of metal hydride alloy, metal nanoparticles, acetylene black, graphite, CMC, and SBR was 88.5:5:2:2:1.5. The slurry solution was spread over a Ni Foam (Inco Special Products) current collector to achieve a target loading between 70-80 mg/cm². The coated electrode is dried in air for one hour and then dried in a vacuum oven overnight. After drying the electrode was lightly calendared to compress the electrode.

### EXAMPLE 2

### Preparation of a NiMH Battery

Size 2032 coin cells were used to make the NiMH cells. The anode electrode was prepared as in Example 1. A cathode electrode was prepared by mixing nickel hydroxide (Kansai Catalyst Co.) with acetylene black (Chevron), graphite (Timcal), carboxymethyl cellulose, and SBR in an 85:5:7.5:1:1.5 ratio. The mixture was applied to a Ni foam current collector, and dried. Total cathode loading was 60 mg/cm². The coin cells comprised ½″ diameter electrodes, punched from the coated electrodes, a single layer of separator (Freudenberg Nonwoven, ⅝″ diameter) disposed between the two electrodes, and two stainless steel spacers. Four drops of electrolyte (7.8M KOH, 0.7M LiOH) were added and the coin cells were crimped shut. The final coin cells had a capacity determined by the cathode of about 18 mAh.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the disclosed invention. Thus, it is intended that the scope of the present invention herein disclosed should not be limited by the particular disclosed embodiments described above or below.

What is claimed is:

1. A composition comprising a metal hydride and a plurality of nano-sized particles of reactive metal particles, the composition suitable for application as an electrode in a nickel-metal hydride battery or hydrogen storage material in a fuel storage system.

2. The composition of claim 1, wherein the nano-sized metal particles comprise between 0.1 wt % and 30 wt % of the overall composition.

3. The composition of claim 2, wherein the nano-sized metal particles comprise between 1 wt % and 5 wt % of the overall composition.

4. The composition of claim 2, wherein the nano-sized metal particles comprise between 5 wt % and 10 wt % of the overall composition.

5. The composition of claim 1, wherein the nano-sized metal particles are selected from groups IIA, IB, and IIIB-VIIIB of the periodic table.

6. The composition of claim 5, wherein the nano-sized metal particles comprise either nickel, manganese, aluminum, cobalt, copper, tin, palladium, silver, gold, lanthanum, and/or alloys thereof.

7. The composition of claim 1, wherein the metal hydride comprises a multi-component alloy with a nickel and/or nickel alloy enriched surface coating.

8. An electrode comprising the composition of claim 1.

9. A hydrogen storage device comprising the composition of claim 1.
